(19) United States
(12) Patent Application Publication
(10) Pub. No.: US 2022/0414850 A1
(43) Pub. Date: Dec. 29, 2022

(54) METHOD FOR PROCESSING IMAGES AND ELECTRONIC DEVICE

(71) Applicant: BEIJING DAJIA INTRNET INFORMATION TECHNOLOGY CO., LTD., Beijing (CN)

(72) Inventor: Xiaokun LIU, Beijing (CN)

(21) Appl. No.: 17/929,453

(22) Filed: Sep. 2, 2022

Related U.S. Application Data
(63) Continuation of application No. PCT/CN2020/127563, filed on Nov. 9, 2020.

(30) Foreign Application Priority Data
Apr. 30, 2020 (CN) 202010363734.1

(51) Int. Cl. G06T 5/20; G06V 10/22; G06V 10/75; G06T 3/40; G06T 5/00

(52) U.S. Cl. CPC G06T 5/20; G06V 10/22; G06V 10/751; G06T 3/40; G06T 5/003; G06T 2207/30201

(57) ABSTRACT

Provided is a method for processing images, including: determining a target processing region in a target image based on facial key points; acquiring a low-and-mid-frequency image and a low-frequency image corresponding to the target image by filtering the target image; acquiring a first image by adjusting pixel values of pixel points in the target processing region in the low-and-mid-frequency image based on differences between the pixel values of the pixel points in the target processing region in the low-frequency image and pixel values of pixel points at corresponding positions in the low-and-mid-frequency image; and acquiring a second image by adjusting pixel values of pixel points in the target processing region in the first image based on differences between pixel values of pixel points in the target processing region in the target image and the pixel values of the pixel points at corresponding positions in the low-and-mid-frequency image.

### CROSS-REFERENCE TO RELATED APPLICATION

This application is a continuation application of International Application No. PCT/CN2020/127563, filed on Nov. 9, 2020, which claims priority to Chinese Patent Application No. 202010363734.1, filed on Apr. 30, 2020, the disclosures of which are herein incorporated by reference in their entireties.

### TECHNICAL FIELD

The present disclosure relates to the field of image processing technologies, in particular relates to a method for processing images and an electronic device.

### BACKGROUND

With the development of society and the advancement in technology, some of the current image processing applications, such as various portrait processing applications (apps), live streaming apps, and the like, include beauty functions, which can beautify photos or videos and enhance the user's facial attractiveness.

### SUMMARY

According to some embodiments of the present disclosure, a method for processing images is provided. The method includes: determining a target processing region in a target image based on facial key points in the target image; acquiring a low-and-mid-frequency image and a low-frequency image corresponding to the target image by filtering the target image, wherein a frequency of the low-and-mid-frequency image is in a first frequency band, and a frequency of the low-frequency image is in a second frequency band, an upper limit of the second frequency band being lower than a lower limit of the first frequency band and an upper limit of the first frequency band being lower than a frequency of the target image; acquiring a first image by adjusting pixel values of pixel points at corresponding positions in the target processing region in the low-and-mid-frequency image based on differences between the pixel values of the pixel points in the target processing region in the low-frequency image and pixel values of pixel points at the corresponding positions in the low-and-mid-frequency image; and acquiring a second image by adjusting pixel values of pixel points in the target processing region in the first image based on differences between pixel values of pixel points in the target processing region in the target image and the pixel values of the pixel points at corresponding positions in the low-and-mid-frequency image.

According to some embodiments of the present disclosure, an electronic device is provided. The electronic device includes one or more processors, and a memory configured to store one or more instructions executable by the one or more processors, wherein the one or more processors, when loading and executing the one or more instructions, are caused to perform: determining a target processing region in a target image based on facial key points in the target image; acquiring a low-and-mid-frequency image and a low-frequency image corresponding to the target image by filtering the target image, wherein a frequency of the low-and-mid-frequency image is in a first frequency band, and a frequency of the low-frequency image is in a second frequency band, an upper limit of the second frequency band being lower than a lower limit of the first frequency band and an upper limit of the first frequency band being lower than a frequency of the target image; acquiring a first image by adjusting pixel values of pixel points at corresponding positions in the target processing region in the low-and-mid-frequency image based on differences between the pixel values of the pixel points in the target processing region in the low-frequency image and pixel values of pixel points at the corresponding positions in the low-and-mid-frequency image; and acquiring a second image by adjusting pixel values of pixel points in the target processing region in the first image based on differences between pixel values of pixel points in the target processing region in the target image and the pixel values of the pixel points at corresponding positions in the low-and-mid-frequency image.

According to some embodiments of the present disclosure, a non-transitory computer-readable storage medium storing one or more instructions therein is provided. The one or more instructions, when loaded and executed by a processor of an electronic device, cause the electronic device to perform: determining a target processing region in a target image based on facial key points in the target image; acquiring a low-and-mid-frequency image and a low-frequency image corresponding to the target image by filtering the target image, wherein a frequency of the low-and-mid-frequency image is in a first frequency band, and a frequency of the low-frequency image is in a second frequency band, an upper limit of the second frequency band being lower than a lower limit of the first frequency band and an upper limit of the first frequency band being lower than a frequency of the target image; acquiring a first image by adjusting pixel values of pixel points at corresponding positions in the target processing region in the low-and-mid-frequency image based on differences between the pixel values of the pixel points in the target processing region in the low-frequency image and pixel values of pixel points at the corresponding positions in the low-and-mid-frequency image; and acquiring a second image by adjusting pixel values of pixel points in the target processing region in the first image based on differences between pixel values of pixel points in the target processing region in the target image and the pixel values of the pixel points at corresponding positions in the low-and-mid-frequency image.

### BRIEF DESCRIPTION OF THE DRAWINGS

FIG. 1 is a schematic diagram for processing images by a conventional method;

FIG. 2 is a flowchart of a method for processing images according to some embodiments of the present disclosure;

FIG. 3 is a schematic diagram of facial key points as marked according to some embodiments of the present disclosure;

FIG. 4 is a schematic diagram of mask materials of a standard facial image according to some embodiments of the present disclosure;

FIG. 5 is a schematic diagram of a second image according to some embodiments of the present disclosure;

FIG. 6 is a flowchart of a method for processing images according to some embodiments of the present disclosure;

FIG. 7 is a flowchart of a method for removing dark circles and nasolabial folds according to some embodiments of the present disclosure;

FIG. 8 is a block diagram of an apparatus for processing images according to some embodiments of the present disclosure;

FIG. 9 is a block diagram of an electronic device according to some embodiments of the present disclosure; and

FIG. 10 is a block diagram of a terminal device according to some embodiments of the present disclosure.

### DETAILED DESCRIPTION

Some terms in the text are explained below.

1. The term “and/or” in embodiments of the present disclosure describes the association relationship between the associated accounts and indicates that there may be three relationships; for example, A and/or B may indicate three cases where only A exists, A and B exist at the same time, and only B exists. The character “/” generally indicates that the “or” relationship between the former and later associated accounts.

2. The term “electronic device” in embodiments of the present disclosure may be a cell phone, computer, digital broadcast terminal, message sending and receiving device, game console, tablet device, medical device, fitness device, personal digital assistant, and the like.

3. The term “subsampled” in embodiments of the present disclosure is also known as “down-sampled”, which means to zoom out the image. The purpose of the down-sampling is to enable the image to fit the size of the display region and also to generate a thumbnail image of the corresponding image. The down-sampling is implemented by following principles. For an image I with a size of M*N, a resolution image with a size of (M/s)*(N/s) may be acquired by down-sampling the image I with s times. Of course, s shall be a common divisor of M and N. In addition, if the image under consideration is an image in matrix form, the down-sampling refers to changing the image within the s*s window of the original image into a single pixel, and the value of this pixel point is the mean value of all pixels inside the window.

4. The term “up-sampling” in embodiments of the present disclosure is also known as image interpolating, which means to zoom in an image. The main purpose of up-sampling is to zoom in the original image, such that the image can be displayed on a display device having a higher resolution.

5. The term “warp mapping” in embodiments of the present disclosure refers to a linear transformation from two-dimensional coordinates (x, y) to two-dimensional coordinates (u, v). Straight lines are still straight lines after the warp mapping; and the relative positional relationship between the lines remains unchanged, which means that the parallel lines are still parallel lines after the warp mapping, and the position sequence between the points on the lines has no change. Three pairs of corresponding points that are not co-linear may determine a unique warp mapping; and the key points of the image after the warp mapping may still form a triangle, but the shape of the triangle has changed. In short, the warp mapping refers to multiplying a matrix, and the eigenvectors of the matrix determine the direction in which the image transforms.

6. The term “frequency of the image” in embodiments of the present disclosure is not the frequency of a certain point of the image, but an indicator for indicating the degree/speed in changes of the grayscale in the image and is the gradient of grayscale in the plane space. In other words, in a case where a certain region in the image has great or fast changes, this area may carry certain high-frequency information. The more the high-frequency information in an image, the more detailed features the image will have. Information of different frequencies may play different roles in the image structure. The main component of the image is the low-frequency information, which forms the basic grayscale level of the image and plays a rather small role in determining the image structure; the mid-frequency information determines the basic structure of the image and forms the main edge structure of the image; and the high-frequency information forms the edges and details of the image and further enhance the image content based on the mid-frequency information. For example, a large area of desert in the image is a region in which the grayscale changes slow, and thereby correspondingly has a low-frequency value; whereas an edge region with a sharp change in surface properties is a region in which the grayscale changes rapidly in the image, and thereby correspondingly has a high-frequency value. For the image, the edge portion of the image is a sudden changing portion where changes take place rapidly, and therefore correspondingly has a high-frequency component in the frequency domain. Thus, the noise of the image is the high-frequency portion in most cases, and the gradual changing portion of the image is the low-frequency component.

7. The term “low-and-mid-frequency image” in embodiments of the present disclosure refers to an image acquired by filtering the target image (i.e., the image to be processed), and the low-frequency image is also the image acquired by filtering the target image. Compared with the low-frequency image, the low-and-mid-frequency image may retain both the mid-frequency information and the low-frequency information of the target image and filter out the high-frequency information of the target image; whereas the low-frequency image retains only the low-frequency information of the target image and filters out the high-frequency information and the mid-frequency information of the target image. From the effect, the low-and-mid-frequency image is blurrier than the target image, whereas the low-frequency image is blurrier than the low-and-mid-frequency image.

The following is a brief description of the design ideas of embodiments of the present disclosure.

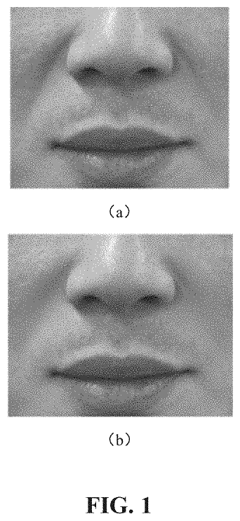

FIG. 1 is a schematic diagram for processing images by a conventional method. As shown in FIG. 1(a) which is a schematic diagram of an original image, the nasolabial folds are very obvious. As shown in FIG. 1(b) which is a pretty image as acquired by the conventional method, the processing trace in the regions corresponding to the nasolabial folds are obvious and the region as processed is too smoothed, thereby causing a poor effect. Similar to the conventional method illustrated in FIG. 1, most beauty apps have the function of removing the dark circles and nasolabial folds, however, the removal may either be inexhaustive, or leave the region missing skin texture after removing the dark circles and nasolabial folds. People do not only pursue the uniformity and softness of the skin, as more and more people tend to be concerned about the texture and realism of skin. The conventional methods for processing an image, while improving some aspects of the images, may remove some important information in the image, or may fail to thoroughly process the image, resulting in a poor processing effect.

In view of this, embodiments of the present application provide a method for processing images, which can remove dark circles and nasolabial folds under the premise of retaining the realism and texture of skin, thereby greatly improving the user experience of beauty cameras, live streaming, and the like. According to this method, the pixel values in the target processing region in the target image are adjusted based on the low-and-mid-frequency image and the low-frequency image, and the realism and texture of the original skin texture are retained while removing the dark circles and nasolabial folds, which enhances the effect of the image processing.

The application scenario described in embodiments of the present disclosure is intended to illustrate the technical solutions of embodiments of the present disclosure more clearly and does not constitute a limitation to the technical solutions according to the embodiments of the present disclosure. It is known to those of ordinary skill in the art that the technical solutions provided by the present application embodiments are equally applicable to similar technical problems with the occurrence of new application scenarios. In the description of the present disclosure, “a plurality of” means two or more, unless otherwise stated.

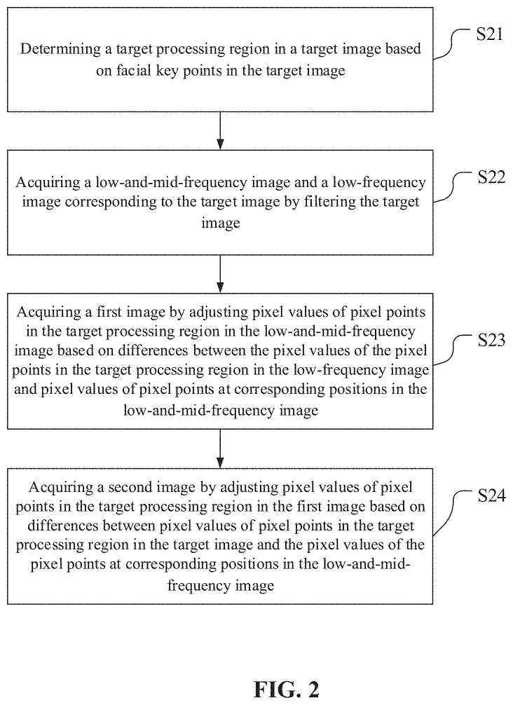

FIG. 2 is a flowchart of a method for processing images according to some embodiments of the present disclosure. As shown in FIG. 2, the method is executed by an electronic device. Exemplarily, the method includes the following steps.

In step S21, a target processing region in a target image is determined based on facial key points in the target image.

The target image is an image to be processed.

In step S22, a low-and-mid-frequency image and a low-frequency image corresponding to the target image are acquired by filtering the target image. A frequency of the low-and-mid-frequency image is in a first frequency band, and a frequency of the low-frequency image is in a second frequency band, an upper limit of the second frequency band is lower than a lower limit of the first frequency band, and an upper limit of the first frequency band is lower than a frequency of the target image.

In step S23, a first image is acquired by adjusting pixel values of pixel points in the target processing region in the low-and-mid-frequency image based on differences between the pixel values of pixel points in the target processing region in the low-frequency image and the pixel value of the pixel point at corresponding positions in the low-and-mid-frequency image.

In step S24, a second image is acquired by adjusting pixel values of pixel points in the target processing region in the first image based on differences between the pixel values of the pixel points in the target processing region in the target image and the pixel values of the pixel points at corresponding positions in the low-and-mid-frequency image.

According to the aforesaid embodiments, taking the region corresponding to nasolabial folds as an example of the target processing region, the region corresponding to nasolabial folds in embodiments of the present disclosure is divided into two layers based on the idea of layered processing. The processing of removing dark circles and nasolabial folds is completed on the lower layer, i.e., the low-and-mid-frequency image, which is specifically implemented by adjusting the pixel values of the pixel points in the target processing region in the low-and-mid-frequency image based on the differences between the low-frequency image and the low-and-mid-frequency image in the pixel values of pixel points in the target processing region. The target processing region refers to the region having dark circles and nasolabial folds. Then, the first image is added with the original skin texture having the dark circles, nasolabial folds, and other imperfections removed, which is implemented by adjusting the first image based on the differences between the target image and the low-and-mid-frequency image in the pixel values of the target processing region. Since the first image is an image acquired by removing the dark circles and nasolabial folds from the low-and-mid-frequency image, the effect of retaining the skin texture while removing the dark circles and nasolabial folds can be achieved by adding the skin texture to the first image, such that the final effect is realistic and natural, thereby enhancing the processing effect.

In some embodiments, the target processing region in the target image based on facial key points is determined based on a mask image, which is a process including:

acquiring a target mask image corresponding to the target image by mapping a mask material of a standard facial image to the target image based on a positional relationship between facial key points in the standard facial image and facial key points in the target image; and determining the target processing region in the target image based on positions of facial regions in the target mask image. The target processing region herein includes at least one of the facial regions.

In some embodiments, in the case of applying the image processing to an image beautification scene, the target processing region may refer to the part of the face to be beautified, and is the facial region to be beautified, which may be a single facial region or a plurality of facial regions, such as a region corresponding to dark circles, a region corresponding to nasolabial folds, and the like. The region corresponding to dark circles and the region corresponding to nasolabial folds are taken as an example of the target processing region below for illustration.

The dataset for the facial key point herein may be in different forms, such as 5 key points, 21 key points, 68 key points, 98 key points, and some datasets may have more than 100 key points. The number of key points as marked in different datasets is different.

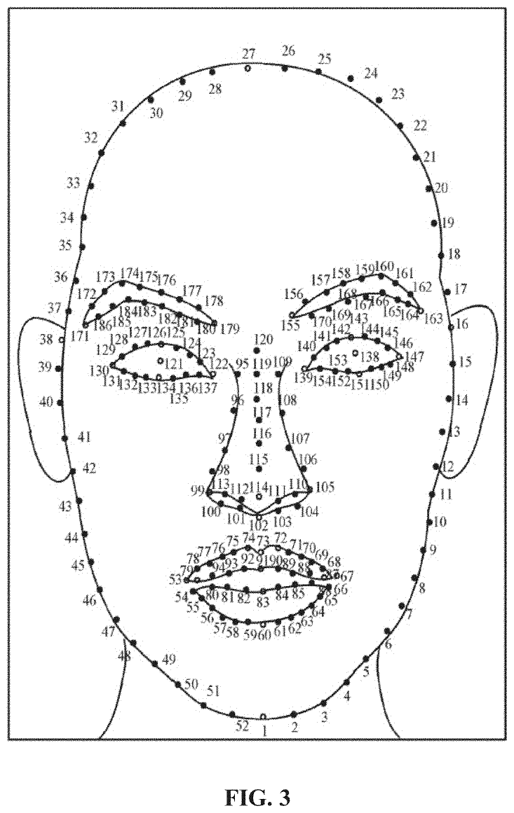

In embodiments of the present application, the dataset for the facial key points as adopted includes 186 key points, which are distinguished by markers 1 to 186. As shown in FIG. 3, which is a schematic diagram of facial key points as marked according to some embodiments of the present disclosure, the key point in the human face is marked in the figure and includes 186 in total. There are 52 key points for marking the facial contour with markers from 1 to 52; there are 42 key points for marking the mouth contour with markers from 53 to 94; there are 26 key points for marking the nose contour with markers from 95 to 120; and there are 34 key points for marking the eye contour (including the eyeball), with 17 for marking the left eye with markers from 121 to 137 and 17 for marking the right eye with markers from 138 to 154. For the 17 key points for marking the left or right eye, one key point thereof is for marking the position in the positive center of the eyeball, and the remaining 16 are for marking the contour of the eye. There are 32 key points for marking the eyebrow contour, 16 of which are for marking the right eyebrow with markers from 155 to 170, and 16 of which are for marking the left eyebrow with markers from 171 to 186. The white key points are the main key points for marking the main positions, such as the eyeball, the corner of eye or mouth, and the like.

In embodiments of the present disclosure, in the case of identifying facial key points of the target image, a facial key point model may be adopted for directly identifying the key points. It shall be noted that in the case of identifying the target image, the dataset of facial key points as acquired is the same as the dataset consisting of facial key points in the standard facial image, which means that the number of key points thereof is the same and may both, for example, be 186 key points. Therefore, after identifying the target image, the facial key points as identified shall also be 186. However, due to the difference between the face in the target image and the standard face in the standard facial image, such as in the eye size, the positions of the key points in the target image as identified may differ from the positions of the key points in the standard facial image, and the markers still in one-to-one correspondence. However, the number of key points as identified may be less than 186 in cases where part of the face in the image is obscured, where the eyes are closed, or where the face is not a frontal but a side face, but this does not affect the implementation of this solution.

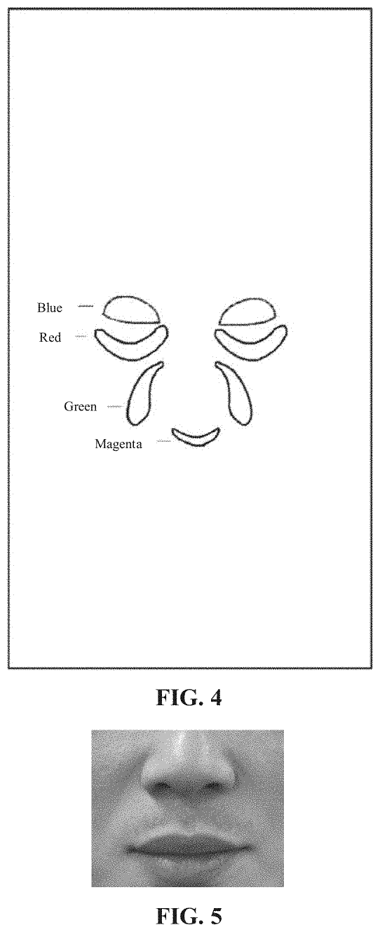

In embodiments of the present disclosure, the mask material of the standard facial image is determined based on the positions between the facial key points in the standard facial image, such as the mask material corresponding to the standard facial image shown in FIG. 4. In a case of acquiring the mask image corresponding to the target image based on the mask material of the standard facial image, the facial key points in the standard facial image may correspond to the facial key points in the target image in one-to-one correspondence, and the positional relationship between the key points in the same image is fixed. For example, among the 52 key points marking the facial contour, key point 1 is adjacent to key point 2, and key point 2 is adjacent to key point 3 . . . . In addition, the positional relationship between the key points in the target image as identified based on the facial key point model is also as follows: key point 1 is adjacent to key point 2, key point 2 is adjacent to key point 3 . . . . Therefore, the mask material of the standard facial image may be mapped (e.g., triangular warp-mapped) to the target image based on the positional relationship between the key points with the same marker in two images, such as the positional relationship between key point 1 in the standard facial image and key point 1 in the image, the positional relationship between key point 2 in the standard facial image and key point 2 in the image, such that the mask image corresponding to the target image can be acquired. Alternatively, the mapping may be understood as adjustment, and the mask material of the standard face may be adjusted based on the positional relationship between the facial key points in the two images, such that the mask image corresponding to the target image can be acquired.

Different facial regions in the mask image may be marked with different marker information. As shown in FIG. 4 (FIG. 4 is a grayscale image, which may affect the display of color values), different facial regions may be marked with different colors while taking the color value as the marker information. For example, the blue region is the eye region, the red region is the dark circle region, the green region is the nasolabial fold region, and the magenta region is the teeth region; and the mask image of the target image is also marked with the same marker information. In this case, when determining the target processing region based on the position in each facial region in the mask image, the target facial region corresponding to the target marker information may be acquired based on the marker information corresponding to each facial region in the target mask image, and the region corresponding to the position in the target facial region in the target image may be taken as the target processing region.

In some embodiments, in the case where the target processing region includes dark circles and nasolabial folds, the target image may be masked based on the red region and green region in the mask image to determine where the target processing region is in the target image. Then, the pixel values of pixel points in the target processing region may be adjusted to achieve the effect of removing dark circles and nasolabial folds.

It shall be noted that the marker information as listed is only an example, and the marker information in any form is applicable to embodiments of the present disclosure. For example, the marker information may be different patterns, numbers, and the like, which will not be listed here.

In aforesaid embodiments, the target processing region can be precisely located based on the facial key point model and the mask image of the standard face. Furthermore, the mask material of the standard facial image is produced with a gradual transition, which causes the image processing effect at the edges of the target processing region to be more natural.

Taking the color value as an example of the marker information, the gradual transition for a certain facial region means that the color value of the region is transitional, with the edge region having a rather light color and the central region having the darkest color. The change from the edge to the center is transitional. For example, for the green region corresponding to nasolabial folds, the green at the edge of the nasolabial folds may take a value of 30, and be displayed as light green; the green at the center of the nasolabial folds may take a value of 255, and be displayed as dark green; and the middle region may be changed in a transitional manner. Thus, when removing the nasolabial folds, the light green portion is removed in a light extent, and the dark green part is removed in a heavy extent, such that the edge portion has a transitional effect.

In some embodiments, acquiring the low-and-mid-frequency image corresponding to the target image by filtering the target image is implemented by a process of:

down-sampling the target image based on a first predetermined factor; filtering the down-sampled target image; and acquiring the low-and-mid-frequency image by up-sampling the filtered target image, a resolution of the low-and-mid-frequency image is equal to a resolution of the target image.

Similarly, acquiring the low-frequency image corresponding to the target image by filtering the target image is implemented by a process of:

down-sampling the target image based on a second predetermined factor that is greater than the first predetermined factor, filtering the down-sampled target image; and acquiring the low-frequency image by up-sampling the filtered target image, a resolution of the low-frequency image herein is equal to a resolution of the target image.

In embodiments of the present disclosure, there are various filtering manners, such as median filtering, mean filtering, Gaussian filtering, bilateral filtering, and the like. In embodiments of the present disclosure, the mean filtering is taken as the main example for illustration in detail. The first predetermined factor and the second predetermined factor are multipliers set in advance. For example, the first predetermined factor is 2 times and the second predetermined factor is 4 times, which are not limited. In some embodiments, the target image is down-sampled by 2 times to acquire an image ds2Img; then, the ds2Img is mean-filtered; and finally the filtered image is up-sampled again to acquire an image blurImg1, i.e., the low-and-mid-frequency image. The mean filtering here may be implemented by a filter kernel of 3*3 with a sampling step of 3, which is not limited.

Alternatively, in the case of down-sampling the target image to acquire a low-frequency image, the electronic device in some embodiments may directly down-sample the target image based on the second predetermined factor (e.g., 4 times) and thereby acquire an image ds4Img. In some other embodiments, after acquiring the image ds2Img by down-sampling the target object based on the first predetermined factor (e.g., 2 times), the electronic device may further down-sample the image ds2Img and acquire the image ds41 mg, which is not limited. After acquiring the image ds4Img, the ds4Img is mean-filtered, and then the filtered image is up-sampled to acquire blurImg2, i.e., the low-frequency image. The mean filtering here may be implemented by a filter kernel of 3*3. In some embodiments, in the case where the ds2Img is further down-sampled to acquire the image ds4Img, the sampling step may be 1.

It shall be noted that the low-frequency image is blurrier than the low-and-mid-frequency image. That is, compared to the low-and-mid-frequency image, the change extent of the grayscale in the low-frequency image is less, and the low-and-mid-frequency image is actually a blurred image in which the general contour of the nasolabial folds is still visible, but the skin texture and eyelashes are not visible. Thus, the low-frequency image is a blurrier image than the low-and-mid-frequency image and does not show the general contour of the nasolabial folds, and the like.

In embodiments of the present disclosure, whether zooming out the image (down-sampling) or zooming in the image (up-sampling), the sampling may be performed in various ways, such as nearest neighbor interpolation, bilinear interpolation, mean interpolation, median interpolation, and other methods, which are not limited here.

In the aforesaid embodiments, the down-sampled image is filtered. Since the down-sampling zooms out the image, the filtering on a relatively small image can effectively reduce the amount of computation and increase the speed of operation compared to the filtering on the original image, thereby improving the efficiency of image processing.

In some embodiments, acquiring the first image by removing the skin texture features in the target processing region from the low-and-mid-frequency image is implemented by a process of:

determining the first target pixel values corresponding to pixel points in the target processing region based on the differences between the pixel values of pixel points in the target processing region in the low-frequency image as acquired by filtering the target image and the pixel values of the pixel points at the corresponding positions in the low-and-mid-frequency image; and acquiring the first image by adjusting the pixel values of the pixel points in the target processing region in the low-and-mid-frequency image based on the first target pixel values as determined. A frequency of the low-frequency image herein is in a second frequency band, and an upper limit of the second frequency band is lower than a lower limit of the first frequency band.

Taking the regions corresponding to dark circles and nasolabial folds as an example of the target processing region, removing the skin texture features in the target processing region in the aforesaid process refers to removing the dark circles and nasolabial folds, which is mainly achieved in two steps. The first step is to remove the texture of the skin from the region corresponding to dark circles and nasolabial folds, and only leave the contour of dark circles and nasolabial folds (this portion is a bit darker in the image). The second step is to further remove the contour of the dark circles and nasolabial folds. Both the first and second steps are achieved by adjusting the pixel value. After removing the skin texture features from the target processing region in the low-and-mid-frequency image by the aforesaid two steps, the first image as acquired may be added with the original skin texture, such that the skin texture can be retained while removing the dark circles and nasolabial folds, thereby achieving a realistic and natural final effect.

In the aforesaid embodiments, the dark circles and nasolabial folds are removed by the layered processing idea. That is, the skin is divided into two layers, where the upper layer is the texture of the skin, and the lower layer is the contour of nasolabial folds, dark circles, and the like. In the target image, the region in dark circles and nasolabial folds may be darker than other regions of the skin. Based on the layered idea, the processing of removing dark circles and nasolabial folds is completed on the lower layer (i.e., the low-and-mid-frequency image), and then the upper layer (i.e., the original skin texture) is added back, so as to achieve a more realistic and natural image processing effect.

The process of acquiring the first image and the second image is described in detail below.

In the process of acquiring the first image, the first target pixel value corresponding to each pixel point in the target processing region shall be determined first.

In some embodiments, determining the first target pixel values corresponding to pixel points in the target processing region based on the differences between the pixel values of pixel points in the target processing region in the low-frequency image and the pixel values of the pixel points at the corresponding positions in the low-and-mid-frequency image includes:

determining, for any one pixel point in the target processing region, the first target pixel value corresponding to the pixel point by an equation of:

texDiff=(blurImg2−blurImg1)*coeff1+coeff2*blurImg2

For any pixel point, texDiff represents the first target pixel value of the pixel point, coeff1 represents the first coefficient, and coeff2 represents the second coefficient. The coeff1 may for example be 1.8, and coeff2 may be 0.05. The blurImg2 represents the pixel value of the pixel point in the low-frequency image, blurImg1 represents the pixel value of the pixel point in the low-and-mid-frequency image, and blurImg2-blurImg1 represents the difference between the pixel value of the pixel point in the low-frequency image and the pixel value of the pixel point in the low-and-mid-frequency image.

The aforesaid formula may be transformed as:

texDiff=blurImg2*(coeff1+coeff2)−blurImg1*coeff1

At this point, the first target pixel value may be expressed as the difference between the product of the target coefficient with the pixel value of each pixel point in the target processing region in the low-frequency image and the product of the first coefficient with the pixel value of the pixel point at the corresponding position in the low-and-mid-frequency image. The target coefficient herein is the sum of the first and second coefficients.

It shall be noted that the first coefficient and the second coefficient are both positive numbers in embodiments of the present disclosure, and the first coefficient is greater than the second coefficient. In general, the second coefficient is smaller, which is around 0.05 such as 0.04 or 0.06; whereas the first coefficient is greater, which is generally greater than 1. In some embodiments, the value of the first coefficient is around 1.8 such as 1.7 or 1.9, and the like.

Taking the nasolabial folds as an example, since the general contour of the nasolabial folds is also visible in the low-and-mid-frequency image in embodiments of the present disclosure, the pixel points in the contour portion may have a little darker color than other skin regions. Therefore, in the case of removing the nasolabial folds from the low-and-mid-frequency image, it is possible to brighten the color of the pixel points at these positions a bit by increasing the pixel values, such that the color of the region may change more smoothly and more closely than the color of the pixel points in the surrounding region, thereby achieving the effect of removing the nasolabial folds. In the case of considering how to brighten the color of the pixel points at the positions, the general contour may be determined based on the differences between the pixel values of the low-frequency image and the low-and-mid-frequency image since the general contour of the nasolabial folds is not visible on the low-frequency image. The aforesaid formula is based on the blurImg2-blurImg1, and takes the pixel values of blurImg1 as a reference, such that the pixel points in the region has a close color with the surrounding region, thereby enhancing the effect of removing the nasolabial folds. The principle is also available for the removal of dark circles.

After the first target pixel value is determined based on the aforesaid formula, the pixel values of pixel points in the target processing region in the low-and-mid-frequency image may be adjusted directly based on the first target pixel values, and then the first image having the dark circles and nasolabial folds removed from the low-and-mid-frequency image may be acquired. The adjustment includes:

acquiring a first target value corresponding to each pixel point by summing each of the first target pixel values with the pixel value of the pixel point at the corresponding position in the target processing region in the low-and-mid-frequency; and comparing the first target value corresponding to each pixel point with a first predetermined pixel value, and acquiring the first image by adjusting, based on comparison results, the pixel values of the pixel points in the target processing region in the low-and-mid-frequency image. The pixel value of each pixel point in the target processing region in the first image is a smaller one of the first target value corresponding to each pixel point and the first predetermined pixel value.

In embodiments of the present disclosure, the adjustment may be implemented for any one pixel point in the target processing region based on the following formula:

tempImg=min(texDiff+blurImg1,1.0)

Where tempImg represents the result of removing dark circles and nasolabial folds from the low-and-mid-frequency image blurImg1, which is the pixel value of any one pixel point in the target processing region in the first image as acquired after the adjustment, 1.0 represents the first preset pixel value, and the first target value is texDiff+blurImg1.

It shall be noted that the case where the first preset pixel value in the formula takes the value of 1.0 corresponds to the case where the pixel value is normalized to a value within 0 to 1, and in the case where 0 to 255 is normalized to a value within 0 to 1, the first preset pixel value takes the value of 1.0, which indicates that the pixel value of the pixel point in tempImg shall not exceed 255. In the case where there is no normalization, the first preset pixel value may take the value of 255 or 254 and the like, as long as the value does not exceed 255 and take a value around 255. In the case where the normalization occurs, the first preset pixel value may take a value no more than 1.0, and a value around 1.0.

Based on the aforesaid formula, the pixel values of pixel points in the target processing region in the low-and-mid-frequency image are adjusted to remove the dark circles and nasolabial folds.

In some other embodiments, the electronic device may fine adjust the first target pixel values, which is a process intended to constrain the color of the pixel points in the low-and-mid-frequency image during the adjustment, so as to prevent the pixel points as adjusted from being over-brightening. Exemplarily, the process includes:

acquiring a second target pixel value corresponding to each of the first target pixel values by adjusting the first target pixel value based on the target adjustment value; acquiring a second target value corresponding to each pixel point by summing the second target pixel value corresponding to each of the first target pixel values with the pixel value of the pixel point in the target processing region in the low-and-mid-frequency image; and comparing the second target value corresponding to each pixel point with a first predetermined pixel value, and acquiring the first image by adjusting, based on comparison results, the pixel values of the pixel points in the target processing region in the low-and-mid-frequency image. The pixel value of each pixel point in the target processing region in the first image is a smaller one of the second target value corresponding to each pixel point and the first predetermined pixel value. The target adjustment value is a preset adjustment value, and may be set according to needs. For example, the target adjustment value may be 0.3, which is not limited.

In some embodiments, the first target pixel value of any pixel point in the target processing region is texDiff and the second target pixel value is texDiff′. Thus, the pixel value of any pixel point in the target processing region in the first image may be calculated by the following formula:

tempImg=min(texDiff′+blurImg1,1.0)

The determining manner is similar to the aforesaid adjusting process as performed based on the first target pixel value, where the first preset pixel value still takes a value of 1.0. The second target value is texDiff+blurImg1.

In some embodiments, acquiring the second target pixel value corresponding to each of the first target pixel values by adjusting the first target pixel value based on the target adjustment value includes:

for any first target pixel value, determining a greater value by comparing the first target pixel value with a second predetermined pixel value; and determining a smaller value, by comparing the greater value with the target adjustment value, as the second target pixel value corresponding to the first target pixel value, wherein the second predetermined pixel value is less than the target adjustment value.

In some embodiments, for any one pixel point in the target processing region, the second target pixel value texDiff is expressed by the following formula:

texDiff′=min(max(0.0,texDiff),coeff3)

Where coeff3 represents the target adjustment value and is configured to constrain the first target pixel value texDiff. In the case that the pixel value is normalized, coeff3 may for example be 0.3 (the value range of coeff3 is between 0 and 1), and texDiff may be constrained to a maximum of 0.3 according to the aforesaid formula. The second preset pixel value may take the value of 0.0 to ensure that texDiff is non-negative.

For example, in the case that the first target pixel value texDiff is 0.2, the second target pixel value texDiff may also be 0.2; and in the case that the first target pixel value texDiff is 0.5, the second target pixel value texDiff may be 0.3 and the like.

In the aforesaid embodiment, the first target pixel value is constrained based on the target adjustment value, which can further improve the effect of removing the dark circles and nasolabial folds.

In some embodiments, acquiring the second image by adjusting the pixel values of the pixel points in the target processing region in the first image based on the difference between the pixel value of each pixel point in the target processing region in the target image and the pixel value of the pixel point at the corresponding position in the low-and-mid-frequency image includes:

acquiring a third target value corresponding to each pixel point in the target processing region by summing a pixel value of a pixel point at a corresponding position in the first image with a difference value between the pixel value of each pixel point in the target processing region in the target image and the pixel value of the pixel point at the corresponding position in the low-and-mid-frequency image; and acquiring the second image by replacing the pixel value of each pixel point in the target processing region in the first image with the corresponding third target value.

In embodiments of the present disclosure, the process of adjusting the first image based on the difference between the low-and-mid-frequency image and the target image is a process that includes adding the original skin texture back based on the result as acquired by removing the dark circles and nasolabial folds. Thus, the process is substantially a process for adjusting the pixel value, which may be expressed by following formulas.

Firstly, a difference value diff between the pixel value of each pixel point in the target processing region in the target image and the pixel value of the pixel point at the corresponding position in the low-and-mid-frequency image blurImg1 is calculated with the formula of:

diff=Target image−blurImg1;

Then, a second image resImg is acquired by adding the diff to the image (tempImg) having the dark circles and nasolabial folds removed with the formula of:

resImg=diff+tempImg

Exemplarily, the pixel value of a certain pixel point in the target processing region in the target image is A1, the pixel value of the pixel point at the corresponding position in the low-and-mid-frequency image is B1, and the pixel value of the pixel point in the first image is C1. Thus, the third target value is A1−B1+C1.

In embodiments of the present disclosure, the effect of preserving the original skin texture after removing the dark circles and nasolabial folds can be achieved by replacing the pixel value of the corresponding pixel point in the first image with the third target value.

In addition, in some embodiments, the aforesaid steps may be performed with a degree of optimization and combination, and the optimization and combination may for example be achieved when the pixel values are adjusted according to following three formulas:

tempImg=min(texDiff′+blurImg1,1.0);

resImg=diff+tempImg; and

diff=Target image−blurImg1

Then, the last two formulas are combined as:

resImg=target image−blurImg1+tempImg

The formula “tempImg=min(texDiff+blurImg1,1.0)” is substituted into the formula “resImg=target image−blurImg1+tempImg” as:

resImg=target image−blurImg1+min(texDiff+blurImg1,1.0)

=min(target image−blurImg1+texDiff+blurImg1,1.0)

=min(texDiff+target image,1.0).

The texDiff herein may also be replaced with texDiff.

That is, the electronic device may, without the need to acquire the first image, directly acquire the second image by making adjustment based on the first target pixel value or the second target pixel value, which is a process including:

acquiring a second target pixel value corresponding each of the first target pixel values (an optional step) after determining the first target pixel value corresponding to each pixel point in the target processing region based on the difference between the pixel value of each pixel point in the target processing region in the low-frequency image as acquired by filtering the target image and the pixel value of the pixel point at the corresponding position in the low-and-mid-frequency image; and

acquiring the target value of each pixel point by summing the pixel value of each pixel point within the target region in the target image and the first target pixel value or the second target pixel value of the pixel point at the corresponding position, which may be expressed as texDiff+target image or texDiff+target image; and determining the pixel value of each pixel point within the target processing region in the second image based on the target value. The pixel value at the position in any pixel point within the target processing region in the second image is a smaller one of the target value of the pixel point and the first preset pixel value. In addition, other optimization and combination manners are also applicable and will not be limited here. The basic idea is still the layered processing based on the low-and-mid-frequency image and low-frequency image.

It shall be noted that, in the second image acquired by the image processing method according to the embodiments of the present disclosure, the pixel values of the pixel points in the regions other than the target processing region are consistent with the pixel values of the pixel points at the corresponding positions in the target image, as long as it can ensure that the difference between the final second image and the target image is only in the target processing region. By removing the dark circles and nasolabial folds with the image processing method according to embodiments of the present disclosure, the original texture and realism of the skin can be preserved after removing the dark circles and nasolabial folds, thereby enhancing the processing effect.

As shown in FIG. 5, it is an effect diagram as acquired after removing the nasolabial folds according to embodiments of the present disclosure. Referring to FIG. 1(b), although the nasolabial folds are removed in the effect diagram shown in FIG. 1(b), the original skin texture of the region in nasolabial folds is also lost, which causes the region to be over-smoothed after removing the nasolabial folds. Compared with the effect diagram in FIG. 1(b), the effect diagram in FIG. 5 shows that the image processed by the method of the present disclosure is more natural since the texture of the original skin is preserved after removing the nasolabial folds.

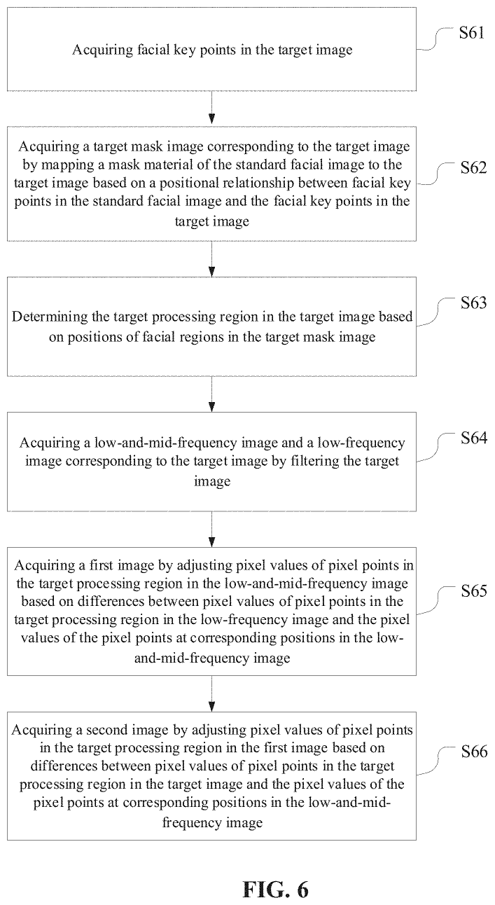

FIG. 6 is a flowchart of a method for processing images according to some embodiments of the present disclosure, which includes following steps.

In step S61, the facial key points in the target image are acquired.

In step S62, the target mask image corresponding to the target image is acquired by mapping a mask material of the standard facial image to the target image based on a positional relationship between facial key points in the standard facial image and the facial key points in the target image.

In step S63, the target processing region in the target image is determined based on positions of facial regions in the target mask image.

In step S64, the low-and-mid-frequency image and the low-frequency image corresponding to the target image are acquired by filtering the target image.

In step S65, the first image is acquired by adjusting pixel values of pixel points in the target processing region in the low-and-mid-frequency image based on differences between the pixel values of the pixel points in the target processing region in the low-frequency image and pixel values of pixel points at corresponding positions in the low-and-mid-frequency image.

In step S66, the second image is acquired by adjusting pixel values of pixel points in the target processing region in the first image based on differences between the pixel values of the pixel points in the target processing region in the target image and the pixel values of the pixel points at corresponding positions in the low-and-mid-frequency image.

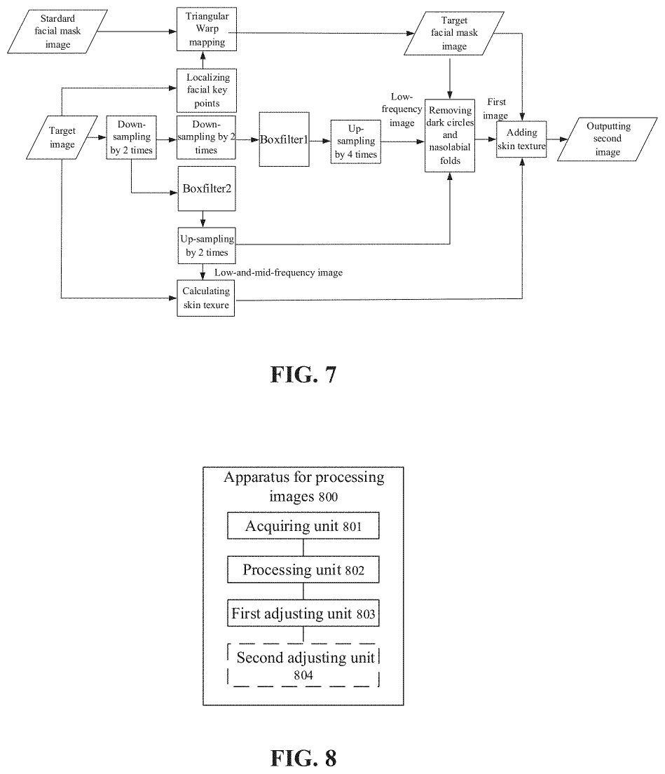

In a case where the aforesaid method is applied to beautification scenes, a reference may be made to FIG. 7 which is a flowchart of a method for removing dark circles and nasolabial folds according to some embodiments of the present disclosure. The method is divided into three branches: acquiring a mask image of the target image based on the facial key points, acquiring a low-and-mid-frequency image corresponding to the target image and acquiring a low-frequency image corresponding to the target image, which are detailed below in conjunction with FIG. 7.

In the process of acquiring the low-frequency image and the low-and-mid-frequency image, the target image is down-sampled based on the first predetermined factor (e.g., 2 times), and the process is divided into following two branches.

In the process of acquiring the low-frequency image, the down-sampling is further performed based on the first predetermined factor (e.g., 2 times), and then, the filtering is further performed by a boxfilter 1, such that the low-frequency image is acquired by performing the up-sampling based on the second predetermined factor (e.g., 4 times).

In the process of acquiring the low-and-mid-frequency image, the image as acquired by down-sampling (e.g., 2 times) the target image is filtered by a boxfilter 2, and the low-and-mid-frequency image is acquired by up-sampling (e.g., 2 times) the image as filtered by the boxfilter 2.

In the process of acquiring the mask image of the target image, the facial key points in the target image are localized, and then, the triangular Warp mapping from the mask material of the standard facial image to the target image is completed based on the positional relationship between the facial key points as localized and the facial key points in the standard facial image, such that the target mask image corresponding to the target image is acquired.

After acquiring the aforesaid image based on the three branches, the target processing region in the target image is determined based on the mask image, such that the skin texture (i.e., the diff) is calculated based on the difference between the target image and the low-and-mid-frequency image in the pixel points within the target processing region. Then, the first image is acquired by removing the dark circles and nasolabial folds on the low-and-mid-frequency image based on the difference between the low-and-mid-frequency image and the low-frequency image. Finally, the second image is acquired by adding the skin texture to the first image. It shall be noted that the aforesaid processing is only for the target processing region as long as it can ensure that the difference between the second image and the target image exists only in the target processing region.

FIG. 8 is a block diagram of an apparatus for processing images according to some embodiments of the present disclosure. Referring to FIG. 8, the device includes an acquiring unit 801, a processing unit 802, a first adjusting unit 803, and a second adjusting unit 804.

The acquiring unit 801 is configured to determine a target processing region in a target image based on facial key points in the target image.

The processing unit 802 is configured to acquire a low-and-mid-frequency image and a low-frequency image corresponding to the target image by filtering the target image, wherein a frequency of the low-and-mid-frequency image is in a first frequency band, and a frequency of the low-frequency image is in a second frequency band, an upper limit of the second frequency band being lower than a lower limit of the first frequency band and an upper limit of the first frequency band being lower than a frequency of the target image.

The first adjusting unit 803 is configured to acquire a first image by adjusting pixel values of pixel points in the target processing region in the low-and-mid-frequency image based on differences between the pixel values of the pixel points in the target processing region in the low-frequency image and pixel values of pixel points at corresponding positions in the low-and-mid-frequency image.

The second adjusting unit 804 is configured to acquire a second image by adjusting pixel values of pixel points in the target processing region in the first image based on differences between the pixel values of the pixel points in the target processing region in the target image and the pixel values of the pixel points at corresponding positions in the low-and-mid-frequency image.

In some embodiments, the acquiring unit 801 is configured to:

acquire a target mask image corresponding to the target image by mapping a mask material of a standard facial image to the target image based on a positional relationship between facial key points in the standard facial image and the facial key points in the target image; and

determine the target processing region in the target image based on positions of facial regions in the target mask image, wherein the target processing region comprises at least one of the facial regions.

In some embodiments, the processing unit 802 is configured to:

down-sample the target image based on a first predetermined factor;

filter the down-sampled target image; and

acquire the low-and-mid-frequency image by up-sampling the filtered target image. A resolution of the low-and-mid-frequency image is equal to a resolution of the target image.

In some embodiments, the processing unit 802 is configured to:

down-sample the target image based on a second predetermined factor, the second predetermined factor being greater than the first predetermined factor;

filter the down-sampled target image; and

acquire the low-frequency image by up-sampling the filtered target image, a resolution of the low-and-mid-frequency image is equal to a resolution of the target image.

In some embodiments, the first adjusting unit 803 is configured to:

determine first target pixel values corresponding to pixel points in the target processing region based on the differences between the pixel values of the pixel points in the target processing region in the low-frequency image and the pixel values of the pixel points at the corresponding positions in the low-and-mid-frequency image; and

acquire the first image by adjusting the pixel values of the pixel points in the target processing region in the low-and-mid-frequency image based on the first target pixel values as determined.

In some embodiments, the first adjusting unit 803 is configured to perform steps of:

determining, for any one pixel point in the target processing region, the first target pixel value corresponding to the pixel point by a formula of:

texDiff=(blurImg2−blurImg1)*coeff1+coeff2*blurImg2;

where texDiff represents the first target pixel value of the pixel point; BlurImg2 represents the pixel value of the pixel point in the low-frequency image; blurImg1 represents the pixel value of the pixel point in the low-and-mid-frequency image; coeff1 represents a first coefficient; coeff2 represents a second coefficient; and the first coefficient is greater than the second coefficient that is a positive number.

In some embodiments, the first adjusting unit 803 is configured to:

acquire a first target value corresponding to each pixel point by summing each of the first target pixel values with the pixel value of the pixel point at the corresponding position in the target processing region in the low-and-mid-frequency image; and

compare the first target value corresponding to each pixel point with a first predetermined pixel value, and acquiring the first image by adjusting, based on comparison results, the pixel values of the pixel points in the target processing region in the low-and-mid-frequency image, wherein the pixel value of each pixel point in the target processing region in the first image is a smaller one of the first target value corresponding to each pixel point and the first predetermined pixel value.

In some embodiments, the first adjusting unit 803 is configured to:

acquire a second target pixel value corresponding to each of the first target pixel values by adjusting the first target pixel value based on a target adjustment value;

acquire a second target value corresponding to each pixel point by summing the second target pixel value corresponding to each of the first target pixel values with the pixel value of the pixel point in the target processing region in the low-and-mid-frequency image; and

compare the second target value corresponding to each pixel point with a first predetermined pixel value, and acquiring the first image by adjusting, based on comparison results, the pixel values of the pixel points in the target processing region in the low-and-mid-frequency image, wherein the pixel value of each pixel point in the target processing region in the first image is a smaller one of the second target value corresponding to each pixel point and the first predetermined pixel value.

In some embodiments, the first adjusting unit 803 is configured to:

for any first target pixel value, determine a greater value by comparing the first target pixel value with a second predetermined pixel value; and

determine a smaller value, by comparing the greater value with the target adjustment value, as the second target pixel value corresponding to the first target pixel value, wherein the second predetermined pixel value is less than the target adjustment value.

In some embodiments, the second adjusting unit 804 is configured to:

acquire a third target value corresponding to each pixel point in the target processing region by summing a pixel value of a pixel point at a corresponding position in the first image with a difference value between the pixel value of each pixel point in the target processing region in the target image and the pixel value of the pixel point at the corresponding position in the low-and-mid-frequency image; and

acquire the second image by replacing the pixel value of each pixel point in the target processing region in the first image with the corresponding third target value.

With regard to the apparatus in the aforesaid embodiments, the specific manner in which the respective units perform the requests has been described in detail in embodiments of the method, and will not be explained in detail herein.

FIG. 9 is a block diagram of an electronic device according to some embodiments of the present disclosure. The electronic device includes:

one or more processors 910; and

a memory 920 configured to store one or more instructions executable by the one or more processors 910.

The one or more processors 910, when loading and executing the one or more instructions, are caused to perform the method for processing images according to aforesaid embodiments.

In some embodiments, a non-transitory computer-readable storage medium storing one or more instructions therein is provided, wherein the one or more instructions, when loaded and executed by a processor 910 of an electronic device 900, cause the electronic device to perform the method for processing images. For example, the non-transitory computer-readable storage medium may be a ROM, a random-access memory (RAM), a CD-ROM, a magnetic tape, a floppy disk, an optical data storage device or the like.

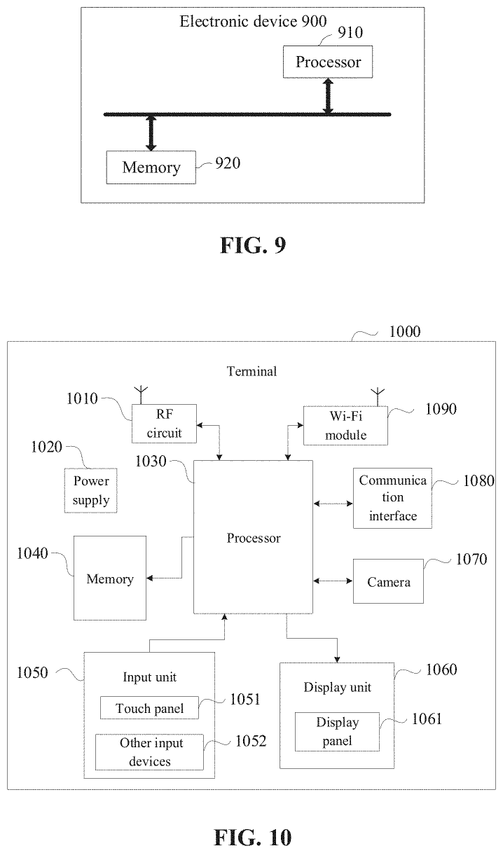

According to embodiments of the present disclosure, a terminal device is further provided and has a structure as shown in FIG. 10. A terminal 1000 for processing the image is given in embodiments of the present disclosure, and includes components such as a radio frequency (RF) circuit 1010, a power supply 1020, a processor 1030, a memory 1040, an input unit 1050, a display unit 1060, a camera 1070, a communication interface 1080, a wireless fidelity (Wi-Fi) module 1090 and the like. It will be understood by those skilled in the art that the structure of the terminal as shown in FIG. 10 does not constitute a limitation to the terminal. The terminal according to embodiments of the present disclosure may include more or less components than those illustrated, or combine some components or adopt different component arrangements.

The various components of the terminal 1000 will be described below in conjunction with FIG. 10.

The RF circuit 1010 may be configured to receive and send data during the communication or calls. In particular, the RF circuit 1010, after receiving the downlink data from the base station, may send the data to the processor 1030 for processing, and further send the uplink data to be sent to the base station. Typically, the RF circuit 1010 includes, but is not limited to, an antenna, at least one amplifier, a transceiver, a coupler, a low noise amplifier (LNA), a duplexer, and the like.

In addition, the RF circuit 1010 may also communicate with networks and other terminals via the wireless communication. The wireless communication may be implemented by any one communication standard or protocol, which includes, but is not limited to, a global system of mobile communication (GSM), general packet radio service (GPRS), code division multiple access (CDMA), wideband code division multiple access (WCDMA), long term evolution (LTE), e-mail, short messaging service (SMS), and the like.

The Wi-Fi technology is a short-range wireless transmission technology, and the terminal 1000 may connect to an access point (AP) via the Wi-Fi module 1090 and thereby access to the data network. The Wi-Fi module 1090 may be configured to receive and send data during the communication process.

The terminal 1000 may be physically connected to other terminals via the communication interface 1080. In some embodiments, the communication interface 1080 is connected to the communication interface of other terminals via a cable to enable data transmission between the terminal 1000 and other terminals.

In embodiments of the present disclosure, the terminal 1000 may send information to other contacts via the communication service. Thus, the terminal 1000 needs to have a data transmission function, which means that the terminal 1000 shall include a communication module. Although FIG. 10 shows communication modules such as the RF circuit 1010, the Wi-Fi module 1090, and the communication interface 1080, it is understood that the terminal 1000 has at least one of the components or other communication modules (e.g., Bluetooth modules) for implementing the communication, so as to enable the data transmission.

For example, in a case where the terminal 1000 is a cell phone, the terminal 1000 may include the RF circuit 1010 and further include the Wi-Fi module 1090; in a case where the terminal 1000 is a computer, the terminal 1000 may include the communication interface 1080 and further include the Wi-Fi module 1090; and in a case where the terminal 1000 is a tablet, the terminal 1000 may include the Wi-Fi module.

The memory 1040 may be configured to store the software programs and modules. The processor 1030 may perform various functional applications and data processing of the terminal 1000 by running the software programs and modules stored in the memory 1040. In a case where the processor 1030 executes the program code in the memory 1040, some or all of the processes shown in FIG. 2 of embodiments of the present disclosure may be implemented.

In some embodiments, the memory 1040 may primarily include a program storing region and a data storing region. The program storing region may store the operating system, various applications (e.g., communication applications), face identifying modules, and the like; the data storing region may store data (e.g., various multimedia files such as pictures and video files, and face information templates) as created during the use of the terminal.

In addition, the memory 1040 may include a high-speed random-access memory, and may further include a non-transitory memory, such as at least one disk memory device, flash memory device, or other solid state memory devices.

The input unit 1050 may be configured to receive numeric or character information input by the user, and to generate key signal input related to user settings and functional control of the terminal 1000.

In some embodiments, the input unit 1050 may include a touch panel 1051 and other input devices 1052.

The touch panel 1051, also known as a touch screen, may collect the user's touch operation on or near the panel (such as the user's operation on or near the touch panel 1051 by any suitable object or attachment such as a finger, stylus, and the like), and drive the corresponding connection device according to a predetermined program. In some embodiments, the touch panel 1051 may include two components, i.e., a touch detection device and a touch controller. The touch detection device detects the user's touch orientation, detects the signal brought by the touch operation, and sends the signal to the touch controller. The touch controller receives the touch information from the touch detection device, converts into contact coordinates, and sends the contact coordinates to the processor 1030; and the touch controller may further receive and execute commands from the processor 1030. The touch panel 1051 may be implemented by various manners such as resistive, capacitive, infrared, and surface acoustic wave.

In some embodiments, the other input devices 1052 may include, but be not limited to, one or more of a physical keyboard, function keys (such as volume control buttons, switch buttons, etc.), trackball, mouse, joystick, and the like.

The display unit 1060 may be configured to display information entered by the user or provided to the user and various menus of the terminal 1000. The display unit 1060 is a display system of the terminal 1000 and is configured to present the interface for human-computer interaction.

The display unit 1060 may include a display panel 1061. In some embodiments, the display panel 1061 may be configured in the form of a liquid crystal display (LCD), an organic light-emitting diode (OLED), and the like.

Furthermore, the touch panel 1051 may cover the display panel 1061. In a case of detecting a touch operation on or near the touch panel, the touch panel 1051 may transmit the touch operation to the processor 1030 for determining the type of touch event, and subsequently the processor 1030 provides a corresponding visual output on the display panel 1061 based on the type of touch event.

Although the touch panel 1051 and the display panel 1061 in FIG. 10 are taken as two separate components to implement the input and output functions of the terminal 1000, the touch panel 1051 in some embodiments may be integrated with the display panel 1061 to implement the input and output functions of the terminal 1000.

The processor 1030 is a control center of the terminal 1000. The processor 1030 is connected to various components via various interfaces and lines, and configured to perform various functions and process data of the terminal 1000 by running or executing software programs and/or modules stored in the memory 1040 and by calling data stored in the memory 1040, thereby realizing various services based on the terminal.

In some embodiments, the processor 1030 may include one or more processing units. In some embodiments, the processor 1030 may be integrated with an application processor and a modem processor. The application processor primarily handles the operating system, user interface, application, and the like, and the modem processor primarily handles the wireless communication. It is understood that the aforesaid modem processor may also not be integrated into the processor 1030.

The camera 1070 for implementing the shooting function of the terminal 1000 may takes pictures or videos. The camera 1070 may also be configured to implement the scanning function of the terminal 1000 for scanning accounts (QR codes/barcodes).

The terminal 1000 further includes a power supply 1020 (e.g., a battery) for powering the various components. In some embodiments, the power supply 1020 may be logically connected to the processor 1030 via a power management system, and thereby enable functions of managing the charging, discharging, and power consumption via the power management system.

It shall be noted that the processor 1030 according to embodiments of the present disclosure may perform functions of the processor 910 in FIG. 9, and the memory 1040 stores the contents of memory 920.

According to embodiments of the present disclosure, a computer program product is provided. The computer program product, when run on an electronic device, causes the electronic device to perform any one of the methods for processing images according to the embodiments described above or any possible methods for processing images involved in embodiments of the present disclosure.

All embodiments of the present disclosure may be performed alone or in combination with other embodiments, which are all considered to be within the protection scope claimed by the present disclosure.

What is claimed is:

1. A method for processing images, comprising:
determining a target processing region in a target image based on facial key points in the target image;
acquiring a low-and-mid-frequency image and a low-frequency image corresponding to the target image by filtering the target image, wherein a frequency of the low-and-mid-frequency image is in a first frequency band, and a frequency of the low-frequency image is in a second frequency band, an upper limit of the second frequency band is lower than a lower limit of the first frequency band and an upper limit of the first frequency band is lower than a frequency of the target image;
acquiring a first image by adjusting pixel values of pixel points at corresponding positions in the target processing region in the low-and-mid-frequency image based on differences between the pixel values of the pixel points in the target processing region in the low-frequency image and pixel values of pixel points at the corresponding positions in the low-and-mid-frequency image; and
acquiring a second image by adjusting pixel values of pixel points in the target processing region in the first image based on differences between pixel values of pixel points in the target processing region in the target image and the pixel values of the pixel points at corresponding positions in the low-and-mid-frequency image.

2. The method according to claim 1, wherein said determining the target processing region in the target image based on the facial key points in the target image comprises:
acquiring a target mask image corresponding to the target image by mapping a mask material of a standard facial image to the target image based on a positional relationship between facial key points in the standard facial image and the facial key points in the target image; and
determining the target processing region in the target image based on positions of facial regions in the target mask image, wherein the target processing region comprises at least one of the facial regions.

3. The method according to claim 1, wherein said acquiring the low-and-mid-frequency image corresponding to the target image by filtering the target image comprises:
down-sampling the target image based on a first predetermined factor,
filtering the down-sampled target image; and
acquiring the low-and-mid-frequency image by up-sampling the filtered target image, wherein a resolution of the low-and-mid-frequency image is equal to a resolution of the target image.

4. The method according to claim 1, wherein said acquiring the low-frequency image corresponding to the target image by filtering the target image comprises:
down-sampling the target image based on a second predetermined factor,
filtering the down-sampled target image; and
acquiring the low-frequency image by up-sampling the filtered target image, wherein a resolution of the low-frequency image is equal to a resolution of the target image.

5. The method according to claim 1, wherein said acquiring the first image by adjusting the pixel values of the pixel points at corresponding positions in the target processing region in the low-and-mid-frequency image based on the differences between the pixel values of pixel points in the target processing region in the low-frequency image and the pixel values of the pixel points at the corresponding positions in the low-and-mid-frequency image comprises:
determining first target pixel values corresponding to pixel points in the target processing region based on the differences between the pixel values of the pixel points in the target processing region in the low-frequency image and the pixel values of the pixel points at the corresponding positions in the low-and-mid-frequency image; and
acquiring the first image by adjusting the pixel values of the pixel points at the corresponding positions in the target processing region in the low-and-mid-frequency image based on the first target pixel values as determined.

6. The method according to claim 5, wherein said determining the first target pixel values corresponding to pixel points in the target processing region based on the differences between the pixel values of pixel points in the target processing region in the low-frequency image and the pixel values of the pixel points at the corresponding positions in the low-and-mid-frequency image comprises:
determining, for any one pixel point in the target processing region, the first target pixel value corresponding to the pixel point by an equation of:
texDiff=(blurImg2−blurImg1)*coeff1+coeff2*blurImg2;
wherein texDiff represents the first target pixel value of the pixel point; blurImg2 represents the pixel value of the pixel point in the low-frequency image; blurImg1 represents the pixel value of the pixel point in the low-and-mid-frequency image; coeff1 represents a first coefficient; coeff2 represents a second coefficient; and the first coefficient is greater than the second coefficient that is a positive number.

7. The method according to claim 5, wherein said acquiring the first image by adjusting the pixel values of the pixel points in the target processing region in the low-and-mid-frequency image based on the first target pixel values as determined comprises:
acquiring a first target value corresponding to each pixel point by summing each of the first target pixel values with the pixel value of the pixel point at the corresponding position in the target processing region in the low-and-mid-frequency image; and
comparing the first target value corresponding to each pixel point with a first predetermined pixel value, and acquiring the first image by adjusting, based on comparison results, the pixel values of the pixel points in the target processing region in the low-and-mid-frequency image, wherein the pixel value of each pixel point in the target processing region in the first image is a smaller one of the first target value corresponding to each pixel point and the first predetermined pixel value.

8. The method according to claim 5, wherein said acquiring the first image by adjusting the pixel values of the pixel points at corresponding positions in the target processing region in the low-and-mid-frequency image based on the first target pixel values as determined comprises:
acquiring a second target pixel value corresponding to each of the first target pixel values by adjusting the first target pixel value based on a target adjustment value;
acquiring a second target value corresponding to each pixel point by summing the second target pixel value corresponding to each of the first target pixel values with the pixel value of the pixel point in the target processing region in the low-and-mid-frequency image; and
comparing the second target value corresponding to each pixel point with a first predetermined pixel value, and acquiring the first image by adjusting, based on comparison results, the pixel values of the pixel points in the target processing region in the low-and-mid-frequency image, wherein the pixel value of each pixel point in the target processing region in the first image is a smaller one of the second target value corresponding to each pixel point and the first predetermined pixel value.

9. The method according to claim 8, wherein said acquiring the second target pixel value corresponding to each of the first target pixel values by adjusting the first target pixel value based on the target adjustment value comprises:
for any first target pixel value, determining a greater value by comparing the first target pixel value with a second predetermined pixel value; and
determining a smaller value, by comparing the greater value with the target adjustment value, as the second target pixel value corresponding to the first target pixel value, wherein the second predetermined pixel value is less than the target adjustment value.

10. The method according to claim 1, wherein said acquiring the second image by adjusting the pixel values of the pixel points in the target processing region in the first image based on the difference between the pixel value of each pixel point in the target processing region in the target image and the pixel value of the pixel point at the corresponding position in the low-and-mid-frequency image comprises:
acquiring a third target value corresponding to each pixel point in the target processing region by summing a pixel value of a pixel point at a corresponding position in the first image with a difference value between the pixel value of each pixel point in the target processing region in the target image and the pixel value of the pixel point at the corresponding position in the low-and-mid-frequency image; and
acquiring the second image by replacing the pixel value of each pixel point in the target processing region in the first image with the corresponding third target value.

11. An electronic device, comprising:
one or more processors; and
a memory configured to store one or more instructions executable by the one or more processors,
wherein the one or more processors, when loading and executing the one or more instructions, are caused to perform:
determining a target processing region in a target image based on facial key points in the target image;
acquiring a low-and-mid-frequency image and a low-frequency image corresponding to the target image by filtering the target image, wherein a frequency of the low-and-mid-frequency image is in a first frequency band, and a frequency of the low-frequency image is in a second frequency band, an upper limit of the second frequency band is lower than a lower limit of the first frequency band and an upper limit of the first frequency band is lower than a frequency of the target image;
acquiring a first image by adjusting pixel values of pixel points at corresponding positions in the target processing region in the low-and-mid-frequency image based on differences between the pixel values of the pixel points in the target processing region in the low-frequency image and pixel values of pixel points at the corresponding positions in the low-and-mid-frequency image; and
acquiring a second image by adjusting pixel values of pixel points in the target processing region in the first image based on differences between pixel values of pixel points in the target processing region in the target image and the pixel values of the pixel points at corresponding positions in the low-and-mid-frequency image.

12. The electronic device according to claim 11, wherein the one or more processors, when loading and executing the one or more instructions, are caused to perform:
acquiring a target mask image corresponding to the target image by mapping a mask material of a standard facial image to the target image based on a positional relationship between facial key points in the standard facial image and the facial key points in the target image; and
determining the target processing region in the target image based on positions of facial regions in the target mask image, wherein the target processing region comprises at least one of the facial regions.

13. The electronic device according to claim 11, wherein the one or more processors, when loading and executing the one or more instructions, are caused to perform:
down-sampling the target image based on a first predetermined factor,
filtering the down-sampled target image; and
acquiring the low-and-mid-frequency image by up-sampling the filtered target image, wherein a resolution of the low-and-mid-frequency image is equal to a resolution of the target image.

14. The electronic device according to claim 11, wherein the one or more processors, when loading and executing the one or more instructions, are caused to perform:
down-sampling the target image based on a second predetermined factor,
filtering the down-sampled target image; and
acquiring the low-frequency image by up-sampling the filtered target image, wherein a resolution of the low-frequency image is equal to a resolution of the target image.

15. The electronic device according to claim 11, wherein the one or more processors, when loading and executing the one or more instructions, are caused to perform:
determining first target pixel values corresponding to pixel points in the target processing region based on the differences between the pixel values of the pixel points in the target processing region in the low-frequency image and the pixel values of the pixel points at the corresponding positions in the low-and-mid-frequency image; and
acquiring the first image by adjusting the pixel values of the pixel points at the corresponding positions in the target processing region in the low-and-mid-frequency image based on the first target pixel values as determined.

16. The electronic device according to claim 15, wherein the one or more processors, when loading and executing the one or more instructions, are caused to perform:
determining, for any one pixel point in the target processing region, the first target pixel value corresponding to the pixel point by an equation of:
texDiff=(blurImg2−blurImg1)*coeff1+coeff2*blurImg2;
wherein texDiff represents the first target pixel value of the pixel point; blurImg2 represents the pixel value of the pixel point in the low-frequency image; blurImg1 represents the pixel value of the pixel point in the low-and-mid-frequency image; coeff1 represents a first coefficient; coeff2 represents a second coefficient; and the first coefficient is greater than the second coefficient that is a positive number.

17. The electronic device according to claim 15, wherein the one or more processors, when loading and executing the one or more instructions, are caused to perform:
acquiring a first target value corresponding to each pixel point by summing each of the first target pixel values with the pixel value of the pixel point at the corresponding position in the target processing region in the low-and-mid-frequency image; and
comparing the first target value corresponding to each pixel point with a first predetermined pixel value, and acquiring the first image by adjusting, based on comparison results, the pixel values of the pixel points in the target processing region in the low-and-mid-frequency image, wherein the pixel value of each pixel point in the target processing region in the first image is a smaller one of the first target value corresponding to each pixel point and the first predetermined pixel value.

18. The electronic device according to claim 15, wherein the one or more processors, when loading and executing the one or more instructions, are caused to perform:
acquiring a second target pixel value corresponding to each of the first target pixel values by adjusting the first target pixel value based on a target adjustment value;
acquiring a second target value corresponding to each pixel point by summing the second target pixel value corresponding to each of the first target pixel values with the pixel value of the pixel point in the target processing region in the low-and-mid-frequency image; and
comparing the second target value corresponding to each pixel point with a first predetermined pixel value, and acquiring the first image by adjusting, based on comparison results, the pixel values of the pixel points in the target processing region in the low-and-mid-frequency image, wherein the pixel value of each pixel point in the target processing region in the first image is a smaller one of the second target value corresponding to each pixel point and the first predetermined pixel value.

19. The electronic device according to claim 18, wherein the one or more processors, when loading and executing the one or more instructions, are caused to perform:
for any first target pixel value, determining a greater value by comparing the first target pixel value with a second predetermined pixel value; and
determining a smaller value, by comparing the greater value with the target adjustment value, as the second target pixel value corresponding to the first target pixel value, wherein the second predetermined pixel value is less than the target adjustment value.

20. A non-transitory computer-readable storage medium storing one or more instructions therein, wherein the one or more instructions, when loaded and executed by a processor of an electronic device, cause the electronic device to perform:
determining a target processing region in a target image based on facial key points in the target image;
acquiring a low-and-mid-frequency image and a low-frequency image corresponding to the target image by filtering the target image, wherein a frequency of the low-and-mid-frequency image is in a first frequency band, and a frequency of the low-frequency image is in a second frequency band, an upper limit of the second frequency band is lower than a lower limit of the first frequency band and an upper limit of the first frequency band is lower than a frequency of the target image;
acquiring a first image by adjusting pixel values of pixel points at corresponding positions in the target processing region in the low-and-mid-frequency image based on differences between the pixel values of the pixel points in the target processing region in the low-frequency image and pixel values of pixel points at the corresponding positions in the low-and-mid-frequency image; and
acquiring a second image by adjusting pixel values of pixel points in the target processing region in the first image based on differences between pixel values of pixel points in the target processing region in the target image and pixel values of pixel points at corresponding positions in the low-and-mid-frequency image.
